(19) United States
(12) Patent Application Publication
(10) Pub. No.: US 2009/0087684 A1
(43) Pub. Date: Apr. 2, 2009

(54) METHOD OF MODIFYING SURFACE OF POWDER, MAGNETIC RECORDING MEDIUM, AND COATING MATERIAL

(75) Inventors: Kazufumi OMURA, Kanagawa (JP); Tadahiro Ooishi, Kanagawa (JP); Takumi Tsuruoka, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/240,490

(22) Filed: Sep. 29, 2008

(30) Foreign Application Priority Data
Sep. 28, 2007 (JP) 2007-256865
Mar. 27, 2008 (JP) 2008-083969

(51) Int. Cl. G11B 5/62; B32B 5/16; C09D 7/00; H01F 1/42

(52) U.S. Cl. 428/800; 427/212; 106/287.2; 252/62.51 R

(57) ABSTRACT

An aspect of the present invention relates to a method of modifying a surface of a powder, comprising mixing a powder with a heterocyclic compound comprising at least one hydroxylic group and/or carboxylic group. The present invention further relates to a magnetic recording medium and a coating material.

### CROSS-REFERENCE TO RELATED APPLICATIONS

This application claims the benefit of priority under 35 USC 119 to Japanese Patent Application No. 2007-256865 filed on Sep. 28, 2007 and Japanese Patent Application No. 2008-083969 filed on Mar. 27, 2008, which are expressly incorporated herein by reference in their entirety.

### FIELD OF THE INVENTION

The present invention relates to a method of modifying a surface of a powder, more particularly, to a method of modifying a surface of a magnetic powder in a magnetic coating material or a nonmagnetic powder in a nonmagnetic coating material capable of improving dispersibility of the powder.

The preset invention further relates to a magnetic recording medium and a coating material such as magnetic coating material and a nonmagnetic coating material.

### DISCUSSION OF THE BACKGROUND

In recent years, means for rapidly transmitting information have undergone marked development, making it possible to transmit data and images comprising huge amounts of information. As data transmission technology has improved, the need for higher density recording in the recording media and recording and reproduction devices used to record, reproduce, and store information has developed.

In addition to using microgranular magnetic materials, it is known that dispersing microgranular magnetic materials to a high degree and increasing the smoothness of the magnetic layer surface are effective means of achieving good electromagnetic characteristics in the high-density recording region. A magnetic recording medium with a high degree of gloss can also be achieved by increasing the dispersibility of the magnetic material. Still further, increasing the dispersibility of the nonmagnetic powder contained in the nonmagnetic layer positioned beneath the magnetic layer is an effective means of increasing the surface smoothness of the magnetic layer.

As described in Japanese Unexamined Patent Publication (KOKAI) No. 2003-132531 or English language family member US 2003/0143323 A1, for example, one widely employed means of increasing the dispersibility of magnetic powders and other powders employed in magnetic recording media is to incorporate a polar group such as SO₃Na into the binder. The contents of these applications are expressly incorporated herein by reference in their entirety. Phosphonic acid, phosphoric acids and the like are also known additives that effectively enhance dispersion.

Incorporating a polar group into the binder is an effective means of improving dispersibility by causing the binder (polymer) to efficiently adsorb to the surface of magnetic powders and the like. However, when the quantity of polar groups in the binder becomes excessive, there is a risk of decreased dispersion. Accordingly, the use of a dispersing agent is conceivable, but there is no dispersing agent having an adequate dispersion-enhancing effect among the above-mentioned phosphonic acids, phosphoric acids, and the like. Further, when dispersibility is increased by adding a dispersing agent and there is inadequate adsorption of the dispersing agent to the powder surface, there is a risk that free dispersing agent will negatively affect the system. For example, when a large quantity of free dispersing agent is incorporated into the magnetic layer coating liquid of a magnetic recording medium, free dispersing agent can migrate to the surface of the magnetic layer formed with the coating liquid, potentially becoming a factor in lowering running durability.

### SUMMARY OF THE INVENTION

An aspect of the present invention provides for a means of modifying the surface of powders such as magnetic powders in a magnetic coating material to increase the dispersibility thereof, and more particularly, for a means of modifying the surface of powders with a surface-modifying agent that is highly adsorbable to powder and is capable of increasing the amount of binder adsorbing onto powder by modifying the powder surface, as well as for a magnetic coating material and a nonmagnetic coating material containing such surface-modifying agent.

A further aspect of the present invention provides for a magnetic recording medium having good surface smoothness and running durability.

As set forth above, the characteristics demanded of a surface-modifying agent modifying the surface of a powder, particularly a surface-modifying agent modifying the surface of a powder in a system containing a powder and a binder, include: (1) increasing the adsorption of binder to powder, and (2) a high degree of adsorption of the surface-modifying agent itself to the powder. The present inventors conducted extensive research, resulting in the discovery that a compound comprising a hydroxylic group and/or a carboxylic group and a heterocyclic ring had both characteristics (1) and (2) above.

The present invention was devised on the basis of the above discovery.

An aspect of the present invention relates to a method of modifying a surface of a powder, comprising mixing a powder with a heterocyclic compound comprising at least one hydroxylic group and/or carboxylic group.

A further aspect of the present invention relates to a magnetic recording medium comprising a magnetic layer comprising a ferromagnetic powder and a binder on a nonmagnetic support, wherein

the magnetic layer comprises a heterocyclic compound comprising at least one hydroxylic group and/or carboxylic group.

A still further aspect of the present invention relates to a coating material comprising a powder and a binder, further comprising a heterocyclic compound comprising at least one hydroxylic group and/or carboxylic group.

The heterocyclic compound may comprise at least one heterocyclic ring selected from the group consisting of aromatic heterocyclic rings and aliphatic heterocyclic rings.

The aromatic heterocyclic ring may be at least one aromatic heterocyclic ring selected from the group consisting of pyridine, pyrazine, pyrrole, piperidine, thiophene, quinoline, and furan rings.

In the above method of modifying a surface of a powder, the powder may be a magnetic powder or a nonmagnetic powder.

In the above method of modifying a surface of a powder, the powder may be a magnetic powder or a nonmagnetic powder comprised in a coating material, and the surface of the powder may be modified to improve dispersibility of the powder in the coating material.

The above magnetic recording medium may further comprises a nonmagnetic layer comprising a nonmagnetic powder and a binder between the nonmagnetic support and the magnetic layer, and the nonmagnetic layer may comprise the above heterocyclic compound.

The above coating material may be a magnetic coating material comprising the powder in the form of a magnetic powder or a nonmagnetic coating material comprising the powder in the form of a nonmagnetic powder.

The above coating material may be a coating liquid for forming a magnetic layer or a nonmagnetic layer of a magnetic recording medium.

In the above magnetic recording medium and the above coating liquid, the binder may comprise a sulfonic acid group.

The present invention can modify the powder surface and increase the amount of binder adsorbing onto the powder, thereby increasing the dispersibility of a magnetic powder in a magnetic coating material and that of a nonmagnetic powder in a non-magnetic coating material.

Further, the present invention can provide a magnetic recording medium of good surface smoothness and running durability.

Other exemplary embodiments and advantages of the present invention may be ascertained by reviewing the present disclosure.

### DETAILED DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Method of Modifying Surface of Powder

The present invention relates to a method of modifying a surface of a powder. The modifying method of the present invention comprises mixing a powder with a heterocyclic compound comprising at least one hydroxylic group and/or carboxylic group. The above heterocyclic compound can be employed singly or in combination of two or more.

As indicated in Examples described further below, the addition of the above heterocyclic compound to a magnetic coating material has been found to increase the amount of binder adsorbing to the magnetic powder. The present inventors attribute the increase in the amount of binder adsorbing onto the magnetic powder when the above heterocyclic compound is added as set forth above to the following causes.

Acid points and base points (active points) are normally present on the surface of a magnetic powder. Binder is thought to hydrolyze when it comes into contact with the active point, resulting in decrease in the quantity of binder adsorbing to the magnetic powder. By contrast, the heterocyclic compound is thought to block acid points and base points with the heterocyclic ring portion and a hydroxylic group and/or a carboxylic group, resulting in reduction of the chances of the binder coming into direct contact with active points on the surface of the magnetic powder. As a result, the addition of the heterocyclic compound is thought to increasing the amount of binder adsorbing to the magnetic powder.

However, there is a correlation between the capacity of a polar group to adsorb onto the surface of the magnetic powder and the degree of acidity of the polar group; the lower the degree of acidity, the lower the adsorption capacity. The acidity of the hydroxylic group and carboxylic group (such as the hydroxylic group in phenol) in a weakly acidic compound is inadequate to cause a high degree of adsorption onto the surface of a magnetic powder. In systems in which binder is also present, in particular, a portion of the binder adsorbs onto the surface of the magnetic powder. Thus, since the amount of adsorption of the compound added to modify the powder surface to the surface of a magnetic powder is smaller than in a system in which binder is absent, there is a marked drop in the amount of adsorption. When such a compound of inadequate adsorptivity to the surface of magnetic powder is added to modify the surface of the magnetic powder, there may be a risk that it will be unable to adsorb onto the surface of the powder, negatively affecting the system as a free component.

Accordingly, a compound that is heterocyclic in addition to comprising at least one hydroxylic group and/or carboxylic group is employed in the present invention. A compound that is heterocyclic in addition to comprising at least one hydroxylic group and/or carboxylic group has good adsorptivity to magnetic powder. This is thought to be because the heterocyclic ring compensates for an inadequate level of adsorption.

The reason the amount of adsorption of binder onto nonmagnetic powder can be increased by adding the above heterocyclic compound to the nonmagnetic coating material and the reason the heterocyclic compound can adsorb to a high degree onto nonmagnetic powder are thought to be identical or similar to those set forth above.

The above heterocyclic compound (also referred to as “surface-modifying agent”, hereinafter) will be described in greater detail below.

### Heterocyclic Compound

The above heterocyclic compound comprises at least one hydroxylic group (—OH) and/or carboxylic group (—COOH). The heterocyclic compound can contain just a hydroxylic group, just a carboxylic group, or both a hydroxylic group and a carboxylic group. The number of groups selected from among hydroxylic groups and carboxylic groups per molecule of the heterocyclic compound is at least 1, desirably 1 to 5, preferably 1 to 3, and more preferably, 1.

Improving the dispersibility of magnetic powder in a magnetic coating material and the dispersibility of nonmagnetic powder in a nonmagnetic coating material may require causing binder to adhere to the heterocyclic compound adhering to the magnetic powder or nonmagnetic powder. Covering the powder to which the heterocyclic compound has adhered with binder can create a steric hindrance, preventing the aggregation of powders. Compounds capable of functioning in this manner (so-called “surface-modifying agents”) can be cyclic or chainlike in structure. Investigation by the present inventors has revealed that cyclic compounds interact more with binder and adsorb better to powder and binder than do chainlike compounds. This is attributed to the fact that binders generally have cyclic structures, so the ringlike structural portion of the binder interacts significantly with the ringlike structural portion of the heterocyclic compound. Further, as set forth above, the presence of a heterocyclic ring as the ring structure is thought to heighten the powder surface-modifying effect.

Examples of the hetero atoms contained in the heterocyclic ring are nitrogen, oxygen, and sulfur atoms, with nitrogen atoms being desirable. The heterocyclic ring comprises, for example, 1 to 30 carbon atoms, desirably 1 to 20 carbon atoms, and preferably, 1 to 12 carbon atoms. The heterocyclic compound can comprise one or more heterocyclic rings.

Examples of the above heterocyclic ring are aromatic heterocyclic rings and aliphatic heterocyclic rings. Specific examples of aromatic heterocyclic rings are pyrrole, pyrazole, imidazole, pyridine, pyrazine, furan, thiophene, oxazole, thiazole, and quinoline rings; benzo ring condensed products thereof, and heterocyclic ring condensed products thereof. Preferred examples of the above aromatic heterocyclic ring are: pyridine, pyrazine, pyrrole, piperidine, thiophene, quinoline, and furan rings. Of these, various derivatives of pyridine ring compounds are inexpensively available as industrial materials. Thus, from the perspectives of industrial processing and cost, it is advantageous for the surface-modifying agent for powder in the present invention to be an aromatic heterocyclic compound in which the aromatic heterocyclic ring is a pyridine ring. Further, since aromatic heterocyclic groups are electron-withdrawing groups, the electron-withdrawing property can be utilized to increase the acidity of the hydroxylic group and/or carboxylic group, potentially yielding an adsorption capacity that is adequate to effectively modify the powder surface.

Examples of the above aliphatic heterocyclic ring are pyrazoline, pyrrolidine, piperidine, indoline, morpholine, imidazolidine, thiazoline, imidazoline, oxazoline, tetrahydrofuran, tetrahydrothiophene, and tetrahydropyran rings.

Since aliphatic heterocyclic groups are highly hydrophobic, they have the effect of rendering the hydrophilic surfaces of magnetic powder and the like hydrophobic. This effect can potentially be exploited to increase the adsorption rate of binder to powder.

The above heterocyclic compound can comprise substituents in addition to hydroxylic groups and/or carboxylic groups. Examples of such substituents are halogen atoms (such as fluorine, chlorine, bromine, and iodine atoms), cyano groups, nitro groups, alkyl groups having 1 to 16 carbon atoms, alkenyl groups having 1 to 16 carbon atoms, alkynyl groups having 2 to 16 carbon atoms, halogen-substituted alkyl groups having 1 to 16 carbon atoms, alkoxy groups having 1 to 16 carbon atoms, acyl groups having 2 to 16 carbon atoms, alkylthio groups having 1 to 16 carbon atoms, acyloxy groups having 2 to 16 carbon atoms, alkoxycarbonyl groups having 2 to 16 carbon atoms, carbamoyl groups, alkyl-substituted carbamoyl groups having 2 to 16 carbon atoms, and acylamino groups having 2 to 16 carbon atoms. Desirable substituents are halogen atoms, cyano groups, alkyl groups having 1 to 6 carbon atoms, and halogen-substituted alkyl groups having 1 to 6 carbon atoms; preferred substituents are halogen atoms, alkyl groups having 1 to 4 carbon atoms, and halogen-substituted alkyl groups having 1 to 4 carbon atoms; and substituents of greater preference are halogen atoms, alkyl groups having 1 to 3 carbon atoms, and trifluoromethyl groups.

Specific examples of desirable heterocyclic compounds are the compounds employed in Examples, described further below.

The above heterocyclic compounds can be readily synthesized by known methods, and some are available as commercial products.

The quantity of the above heterocyclic compound employed for a powder can be suitably determined. However, when the quantity of heterocyclic compound that is added to a powder in a solution containing powder is excessively large, it is sometimes difficult to ensure a concentration level permitting the powder to function properly. Further, it is undesirable to add an excessively large quantity of heterocyclic compound to a coating liquid for forming a magnetic layer of a magnetic recording medium because the film sometimes plasticizes or separates. From this perspective, the quantity of heterocyclic compound employed is desirably 0.1 to 10 weight parts, preferably 2 to 8 weight parts, per 100 weight parts of powder in the form of magnetic powder or the like. The method of mixing the heterocyclic compound with the powder will be described further below.

The above heterocyclic compound can increase the dispersibility of the powder in the coating material by modifying the powder surface of a magnetic powder, nonmagnetic powder, or the like. Accordingly, the above-heterocyclic compound is desirably employed as a dispersing agent in coating materials f6r forming magnetic recording media, preferably employed as a dispersing agent in magnetic coating materials and nonmagnetic coating materials, and more preferably, employed as a dispersing agent in coating materials for forming a magnetic layer and nonmagnetic layer. Embodiments of applying the heterocyclic compound to magnetic coating materials and nonmagnetic coating materials will be described further below.

### Magnetic Recording Medium

The present invention relates to a magnetic recording medium comprising a magnetic layer comprising a ferromagnetic powder and a binder on a nonmagnetic support. The magnetic recording medium of the present invention comprises a heterocyclic compound comprising at least one hydroxylic group and/or carboxylic group in the magnetic layer.

As set forth above, modifying the surface of a magnetic powder such as a ferromagnetic powder with a heterocyclic compound comprising at least one hydroxylic group and/or carboxylic group can increase the quantity of binder adsorbing onto the surface of the powder and increase the dispersibility of the magnetic layer, thereby yielding a magnetic recording medium of good surface smoothness. Further, the above compound can exhibit good adsorptivity to ferromagnetic powder. When a component that is added to enhance dispersibility has poor adsorptivity to ferromagnetic powder, there may be a risk that large amounts of free component will migrate from the surface of the medium during running and while the medium is being stored, increasing head grime and inviting a drop in running durability. By contrast, when the compound has good adsorptivity to ferromagnetic powder, the dispersibility of the magnetic layer can be enhanced without such problems.

The magnetic recording medium of the present invention can comprise a nonmagnetic layer comprising a nonmagnetic powder and a binder between a nonmagnetic support and the magnetic layer. The above heterocyclic compound can be incorporated into the nonmagnetic layer. Incorporating the above heterocyclic compound into the nonmagnetic layer can increase adsorption of the binder to the nonmagnetic powder and increase the dispersibility of the nonmagnetic layer.

Details regarding the above heterocyclic compound and the quantity in which it is employed relative to the powder are as set forth above.

The magnetic recording medium of the present invention can be formed using the coating material of the present invention. Details regarding the magnetic layer and nonmagnetic layer in the magnetic recording medium of the present invention are identical to those described further below for the coating material of the present invention.

The magnetic recording medium of the present invention will be described in greater detail below.

### Nonmagnetic Support

Examples of the nonmagnetic support are known supports such as biaxially oriented polyethylene terephthalate, polyethylene naphthalene, polyamide, polyamide-imide, and aromatic polyamide. Of these, polyethylene terephthalate, polyethylene naphthalate, and polyamide are preferred. These supports may be treated in advance by corona discharge, plasma processing, adhesion-enhancing treatment, heat treatment, or the like. A nonmagnetic support having a center surface average roughness (Ra) of equal to or less than 6.0 nm, desirably equal to or less than 4.0 nm, as measured by an optical interference surface roughness meter, the HD-2000, made by WYKO Corp., is desirably employed.

### Layer Structure

The magnetic recording medium of the present invention can be in the form of a disk-shaped medium in which a nonmagnetic layer and a magnetic layer are provided on both surfaces of a nonmagnetic support, or in the form of a tape medium or disk-shaped medium in which these layers are provided on just one side. The thickness of the nonmagnetic support is, for example, 2 to 100 micrometers, desirably 2 to 80 micrometers. In the case of a computer tape, nonmagnetic supports ranging in thickness from 3.0 to 6.5 micrometers (desirably 3.0 to 6.0 micrometers, preferably 4.0 to 5.5 micrometers) can be employed.

An undercoating layer can be provided to enhance adhesion between the nonmagnetic support and the magnetic layer or nonmagnetic layer. The undercoating layer is, for example, 0.01 to 0.5 micrometer, desirably 0.02 to 0.5 micrometer, in thickness. A known undercoating layer can be employed.

The thickness of the magnetic layer can be optimized based on the saturation magnetization and head gap length of the magnetic head employed and the band of the recording signal, and is generally 10 to 150 nm, desirably 20 to 120 nm, preferably 30 to 100 nm, and more preferably, 30 to 80 nm. The thickness variation of the magnetic layer is desirably within ±50 percent, preferably within ±30 percent. At least one magnetic layer is sufficient. The magnetic layer may be divided into two or more layers having different magnetic characteristics, and a known configuration relating to multilayered magnetic layer may be applied.

The nonmagnetic layer is, for example, 0.1 to 3.0 micrometers, desirably 0.3 to 2.0 micrometers, and preferably, 0.5 to 1.5 micrometers in thickness. The nonmagnetic layer is effective so long as it is substantially nonmagnetic in the magnetic recording medium of the present invention. For example, it exhibits the effect of the present invention even when it comprises impurities or trace amounts of magnetic material that have been intentionally incorporated, and can be viewed as substantially having the same configuration as the magnetic recording medium of the present invention. The term “substantially nonmagnetic” is used to mean having a residual magnetic flux density in the nonmagnetic layer of equal to or less than 10 mT, or a coercivity of equal to or less than 7.96 kA/m (100 Oe), it being preferable not to have a residual magnetic flux density or coercivity at all.

### Backcoat Layer

A backcoat layer having an antistatic, curl-correcting, or other effect can be provided on the opposite surface of the nonmagnetic support from the surface on which the magnetic layer is provided. A binder and a granular component such as an abrasive or antistatic agent can be dispersed in an organic solvent to prepare a backcoat layer coating material. Various inorganic pigments and carbon black can be employed as the granular component. By way of example, nitrocellulose, phenoxy resin, vinyl chloride resin, polyurethane, and other resins can be employed singly or in the form of mixtures as the binder. The thickness of the backcoat layer is, for example, 0.1 to 4 micrometers, desirably 0.3 to 2.0 micrometers. A known backcoat layer can be employed.

### Method of Manufacturing the Magnetic Recording Medium

The magnetic recording medium of the present invention can be manufactured employing the coating material of the present invention as a magnetic layer coating liquid and/or the nonmagnetic coating liquid. For example, the magnetic coating material and/or nonmagnetic coating material can be coated to a prescribed film thickness on the surface of a nonmagnetic support while running to form a magnetic layer and/or nonmagnetic layer. It is possible to successively or simultaneously coat multiple magnetic coating materials, or successively or simultaneously coat a nonmagnetic coating material and magnetic coating material. Coating machines suitable for use in coating the magnetic or nonmagnetic coating liquid are air doctor coaters, blade coaters, rod coaters, extrusion coaters, air knife coaters, squeeze coaters, immersion coaters, reverse roll coaters, transfer roll coaters, gravure coaters, kiss coaters, cast coaters, spray coaters, spin coaters, and the like. For example, “Recent Coating Techniques” (May 31, 1983), issued by the Sogo Gijutsu Center K.K., which is expressly incorporated herein by reference in its entirety, may be referred to in this regard.

When it is a magnetic tape, the coating layer that is formed by applying the magnetic coating liquid can be magnetic field orientation processed using cobalt magnets or solenoids on the ferromagnetic powder contained in the coating layer. When it is a disk, an adequately isotropic orientation can be achieved in some products without orientation using an orientation device, but the use of a known random orientation device in which cobalt magnets are alternately arranged diagonally, or alternating fields are applied by solenoids, is desirable. In the case of ferromagnetic metal powder, the term “isotropic orientation” generally refers to a two-dimensional in-plane random orientation, which is desirable, but can refer to a three-dimensional random orientation achieved by imparting a perpendicular component. Further, a known method, such as opposing magnets of opposite poles, can be employed to effect perpendicular orientation, thereby imparting an isotropic magnetic characteristic in the peripheral direction. Perpendicular orientation is particularly desirable when conducting high-density recording. Spin coating can be used to effect peripheral orientation.

The drying position of the coating is desirably controlled by controlling the temperature and flow rate of drying air, and coating speed. A coating speed of 20 m/min to 1,000 m/min and a dry air temperature of equal to or higher than 60° C. are desirable. Suitable predrying can be conducted prior to entry into the magnet zone.

The coated stock material thus obtained can be normally temporarily wound on a take-up roll, and then unwound from the take-up roll and calendered. For example, super calender rolls or the like is employed in calendering. Calendering can enhance surface smoothness, eliminate voids produced by the removal of solvent during drying, and increase the fill rate of the ferromagnetic powder in the magnetic layer, thus yielding a magnetic recording medium of good electromagnetic characteristics. The calendering step is desirably conducted by varying the calendering conditions based on the smoothness of the surface of the coated stock material. Rolls of a heat-resistant plastic such as epoxy, polyimide, polyamide, or polyamidoimide, can be employed as the calender rolls. Processing with metal rolls is also possible. Suitable calendering conditions are a calender roll temperature falling within a range, for example, of 60 to 100° C., desirably falling within a range of 70 to 100° C., and preferably falling within a range of 80 to 100° C.; and a pressure falling within a range, for example, of 100 to 500 kg/cm (approximately 98 to 490 kN/m), desirably falling within a range of 200 to 450 kg/cm (approximately 196 to 441 kN/m), and preferably, falling within a range of 300 to 400 kg/cm (approximately 294 to 392 kN/m).

Further, the magnetic recording medium following calendering can be thermoprocessed to promote thermal curing. Thermoprocessing conditions include, by way of example, a temperature of 35 to 100° C., desirably 50 to 80° C. The duration of thermoprocessing is, for example, 12 to 72 hours, desirably 24 to 48 hours.

The magnetic recording medium obtained can be cut to desired size with a cutter or the like for use. The cutter is not specifically limited, but desirably comprises multiple sets of a rotating upper blade (male blade) and lower blade (female blade). The slitting speed, engaging depth, peripheral speed ratio of the upper blade (male blade) and lower blade (female blade) (upper blade peripheral speed/lower blade peripheral speed), period of continuous use of slitting blade, and the like can be suitably selected.

### Physical Properties

Due to the good dispersibility-enhancing effect of the above heterocyclic compound, the magnetic recording medium of the present invention can have extremely good surface smoothness. The surface smoothness of the magnetic recording medium of the present invention desirably ranges from 0.1 to 4 nm, preferably 1 to 3 nm as a center surface average roughness. The ten-point average roughness Rz of the surface of the magnetic layer is desirably equal to or lower than 30 nm. The surface properties of the magnetic layer can be controlled by controlling the surface properties with the filler in the support, the roll surface shape during calendaring, and the like. The curl is desirably within ±3 mm.

The saturation magnetic flux density of the magnetic layer is desirably 100 to 400 mT. The coercivity (Hc) of the magnetic layer is desirably 143.2 to 318.3 kA/m (approximately 1,800 to 4,000 Oe), preferably 159.2 to 278.5 kA/m (approximately 2,000 to 3,500 Oe). Narrower coercivity distribution is preferable. The SFD and SFDr are preferably equal to or lower than 0.6, more preferably equal to or lower than 0.3.

The coefficient of friction of the magnetic recording medium of the present invention relative to the head is desirably equal to or less than 0.70 and preferably equal to or less than 0.5 at temperatures ranging from −10° C. to 40° C. and humidity ranging from 0 percent to 95 percent, the surface resistivity on the magnetic surface preferably ranges from 10⁴ to 10⁸ ohm/sq, and the charge potential preferably ranges from −500 V to +500 V. The modulus of elasticity at 0.5 percent extension of the magnetic layer preferably ranges from 0.98 to 19.6 GPa (approximately 100 to 2,000 kg/mm²) in each in-plane direction. The breaking strength preferably ranges from 98 to 686 MPa (approximately 10 to 70 kg/mm²). The modulus of elasticity of the magnetic recording medium preferably ranges from 0.98 to 14.7 GPa (approximately 100 to 1500 kg/mm²) in each in-plane direction. The residual elongation is preferably equal to or less than 0.5 percent, and the thermal shrinkage rate at all temperatures below 100° C. is preferably equal to or less than 1 percent, more preferably equal to or less than 0.5 percent, and most preferably equal to or less than 0.1 percent.

The glass transition temperature (i.e., the temperature at which the loss elastic modulus of dynamic viscoelasticity peaks as measured at 110 Hz) of the magnetic layer preferably ranges from 50 to 180° C., and that of the nonmagnetic layer preferably ranges from 0 to 180° C. The loss elastic modulus preferably falls within a range of 1×10⁷ to 8×10⁸ Pa (approximately 1×10⁸ to 8×10⁹ dyne/cm²) and the loss tangent is preferably equal to or less than 0.2. Adhesion failure tends to occur when the loss tangent becomes excessively large. These thermal characteristics and mechanical characteristics are desirably nearly identical, varying by equal to or less than 10 percent, in each in-plane direction of the medium.

The residual solvent contained in the magnetic layer is preferably equal to or less than 100 mg/m² and more preferably equal to or less than 10 mg/m². The void ratio in the coated layers, including both the nonmagnetic layer and the magnetic layer, is preferably equal to or less than 30 volume percent, more preferably equal to or less than 20 volume percent. Although a low void ratio is preferable for attaining high output, there are some cases in which it is better to ensure a certain level based on the object. For example, in many cases, larger void ratio permits preferred running durability in disk media in which repeat use is important.

When the magnetic recording medium of the present invention has both a nonmagnetic layer and a magnetic layer, physical properties of the two layers may be varied based on the objective. For example, the modulus of elasticity of the magnetic layer may be increased to improve running durability while simultaneously employing a lower modulus of elasticity than that of the magnetic layer in the nonmagnetic layer to improve the head contact of the magnetic recording medium.

### Coating Material

The coating material of the present invention comprises a powder and a binder, and further comprises a heterocyclic compound comprising at least one hydroxylic group and/or carboxylic group. The coating material of the present invention can be a magnetic coating material comprising a magnetic powder, a binder and the above heterocyclic compound, or a nonmagnetic coating material comprising a nonmagnetic powder, a binder and the above heterocyclic compound. In the magnetic coating material comprising the above heterocyclic compound, the heterocyclic compound can enhance the adhesion between the magnetic powder and the binder, permitting high dispersion of the magnetic powder. Details of the heterocyclic compound are as set forth above.

Various components of the coating material in the form of a magnetic coating material will be described below. These components can be employed as the magnetic layer components in the magnetic recording medium of the present invention.

### Magnetic Powder

Various ferromagnetic powders commonly contained in the coating liquid for forming a magnetic layer of a magnetic recording medium can be employed as the magnetic powder. Among them, ferromagnetic hexagonal ferrite powder and ferromagnetic metal powder are preferred.

(i) Hexagonal Ferrite Powder

Examples of hexagonal ferrite powders are barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed.

As the hexagonal ferrite powder, those having an average plate diameter ranging from 10 to 50 nm are desirably employed. The average plate diameter preferably ranges from 15 to 40 nm, more preferably 15 to 30 nm. The hexagonal ferrite powder with the above-stated size is suitable for use as a magnetic powder for magnetic recording media for high-density recording. According to the present invention, the dispersibility of microgranular hexagonal ferrite powders such as those with the above-described average plate diameter can be improved.

An average plate ratio [arithmetic average of (plate diameter/plate thickness)] preferably ranges from 1 to 15, more preferably 1 to 7. When the average plate diameter ranges from 1 to 15, adequate orientation can be achieved while maintaining high filling property, as well as increased noise due to stacking between particles can be suppressed. The specific surface area by BET method (S_{BET}) within the above particle size range is preferably equal to or higher than 40 m²/g, more preferably 40 to 200 m²/g, and particularly preferably, 60 to 100 m²/g.

Narrow distributions of particle plate diameter and plate thickness of the hexagonal ferrite powder are normally good. About 500 particles can be randomly measured in a transmission electron microscope (TEM) photograph of particles to measure the particle plate diameter and plate thickness, as set forth above. The distributions of particle plate diameter and plate thickness are often not a normal distribution. However, when expressed as the standard deviation to the average size, o/average size may be 0.1 to 1.0. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known. The pH of the hexagonal ferrite powder is normally about 4 to 12 and usually optimum for the dispersion medium and polymer. From the perspective of the chemical stability and storage properties in the medium, a pH of about 6 to 11 can be selected. Moisture contained in the hexagonal ferrite powder also affects dispersion. The moisture content is usually optimum for the dispersion medium and polymer, normally within a range of 0.01 to 2.0.

Methods of manufacturing the hexagonal ferrite powder include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to equal to or greater than 100° C.; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. Any manufacturing method can be selected in the present invention. As needed, the hexagonal ferrite powder can be surface treated with Al, Si, P, or an oxide thereof. The quantity can be set to 0.1 to 10 weight percent of the hexagonal ferrite powder. When applying a surface treatment, the quantity of a lubricant such as a fatty acid that is adsorbed is desirably not greater than 100 mg/m². The hexagonal ferrite powder will sometimes contain inorganic ions such as soluble Na, Ca, Fe, Ni, or Sr. These are desirably substantially not present, but seldom affect characteristics at equal to or less than 200 ppm.

### (ii) Ferromagnetic Metal Powder

The ferromagnetic metal powder employed is not specifically limited, but preferably a ferromagnetic metal power comprised primarily of α-Fe. In addition to prescribed atoms, the following atoms can be contained in the ferromagnetic metal powder: Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B and the like. Particularly, incorporation of at least one of the following in addition to α-Fe is desirable: Al, Si, Ca, Y, Ba, La, Nd, Co, Ni, and B. Incorporation of at least one selected from the group consisting of Co, Y and Al is particularly preferred. The Co content preferably ranges from 0 to 40 atom percent, more preferably from 15 to 35 atom percent, further preferably from 20 to 35 atom percent with respect to Fe. The content of Y preferably ranges from 1.5 to 12 atom percent, more preferably from 3 to 10 atom percent, further preferably from 4 to 9 atom percent with respect to Fe. The Al content preferably ranges from 1.5 to 12 atom percent, more preferably from 3 to 10 atom percent, further preferably from 4 to 9 atom percent with respect to Fe.

The ferromagnetic metal powder may contain a small quantity of hydroxide or oxide. Ferromagnetic metal powders obtained by known manufacturing methods may be employed. The following are examples of methods of manufacturing ferromagnetic metal powders: methods of reduction with compound organic acid salts (chiefly oxalates) and reducing gases such as hydrogen; methods of reducing iron oxide with a reducing gas such as hydrogen to obtain Fe or Fe—Co particles or the like; methods of thermal decomposition of metal carbonyl compounds; methods of reduction by addition of a reducing agent such as sodium boron hydride, hypophosphite, or hydrazine to an aqueous solution of ferromagnetic metal; and methods of obtaining powder by vaporizing a metal in a low-pressure inert gas. Any one from among the known method of slow oxidation, that is, immersing the ferromagnetic metal powder thus obtained in an organic solvent and drying it; the method of immersing the ferromagnetic metal powder in an organic solvent, feeding in an oxygen-containing gas to form a surface oxide film, and then conducting drying; and the method of adjusting the partial pressures of oxygen gas and an inert gas without employing an organic solvent to form a surface oxide film, may be employed.

The specific surface area by BET method of the ferromagnetic metal powder employed is preferably 45 to 100 m²/g, more preferably 50 to 80 m²/g. At 45 m²/g and above, low noise can be achieved. At 100 m²/g and below, good surface properties can be achieved. The crystallite size of the ferromagnetic metal powder is preferably 40 to 180 Angstroms, more preferably 40 to 150 Angstroms, and still more preferably, 40 to 110 Angstroms. The average major axis length (average particle size) of the ferromagnetic metal powder preferably ranges from 10 to 50 nm, more preferably 10 to 40 nm, and further preferably 15 to 30 nm. According to the present invention, the dispersibility of microgranular ferromagnetic metal powders such as those with the above-described average major axis length can be improved. The acicular ratio of the ferromagnetic metal powder is preferably equal to or greater than 3 and equal to or less than 15, more preferably equal to or greater than 3 and equal to or less than 12.

The moisture content of the ferromagnetic metal powder preferably ranges from 0.01 to 2 weight percent. The moisture content of the ferromagnetic metal powder is desirably optimized based on the type of binder. The pH of the ferromagnetic metal powder is desirably optimized depending on what is combined with the binder. A range of 4 to 12 can be established, with 6 to 10 being preferred. As needed, the ferromagnetic metal powder can be surface treated with Al, Si, P, or an oxide thereof. The quantity can be set to 0.1 to 10 weight percent of the ferromagnetic metal powder. When applying a surface treatment, the quantity of a lubricant such as a fatty acid that is adsorbed is desirably not greater than 100 mg/m². The ferromagnetic metal powder will sometimes contain inorganic ions such as soluble Na, Ca, Fe, Ni, or Sr. These are desirably substantially not present, but seldom affect characteristics at equal to or less than 200 ppm. The ferromagnetic metal powder employed in the present invention desirably has few voids; the level is preferably equal to or less than 20 volume percent, more preferably equal to or less than 5 volume percent. As stated above, so long as the particle size characteristics are satisfied, the ferromagnetic metal powder may be acicular, rice grain-shaped, or spindle-shaped.

### Binder

Conventionally known thermoplastic resins, thermosetting resins, reactive resins and mixtures thereof may be employed as binders used. The thermoplastic resins suitable for use have a glass transition temperature of −100 to 150° C., a number average molecular weight of 1,000 to 200,000, preferably from 10,000 to 100,000, and have a degree of polymerization of about 50 to 1,000.

Examples thereof are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins. Further, examples of thermosetting resins and reactive resins are phenol resins, epoxy resins, polyurethane cured resins, urea resins, melamine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. These resins are described in detail in Handbook of Plastics published by Asakura Shoten, which is expressly incorporated herein by reference in its entirety. It is also possible to employ known electron beam-cured resins. Examples and manufacturing methods of such resins are described in Japanese Unexamined Patent Publication (KOKAI) Showa No. 62-256219, which is expressly incorporated herein by reference in its entirety. The above-listed resins may be used singly or in combination. Preferred resins are combinations of polyurethane resin and at least one member selected from the group consisting of vinyl chloride resin, vinyl chloride—vinyl acetate copolymers, vinyl chloride—vinyl acetate—vinyl alcohol copolymers, and vinyl chloride—vinyl acetate—maleic anhydride copolymers, as well as combinations of the same with polyisocyanate. Resins suitable for use as binder can be synthesized by known methods, and may be commercially available.

Known polyurethane resins may be employed, such as polyester polyurethane, polyether polyurethane, polyether polyester polyurethane, polycarbonate polyurethane, polyester polycarbonate polyurethane, and polycaprolactone polyurethane. A binder obtained by incorporating as needed one or more polar groups selected from among —COOM, —SO₃M, —OSO₃M, —P═O(OM)₂, and —O—P═O(OM)₂ (where M denotes a hydrogen atom or an alkali metal base), —OH, —NR₂, —N⁺R₃ (where R denotes a hydrocarbon group), epoxy group, —SH, and —CN into any of the above-listed binders by copolymerization or addition reaction to improve dispersion properties and durability is desirably employed. The quantity of such a polar group ranges from 10⁻¹ to 10⁻⁸ mol/g, preferably from 10⁻² to 10⁻⁶ mol/g. In particular, the above-described cyclic compound is preferably employed together with the sulfonic acid group-containing binder.

The quantity of binder added to the magnetic coating material ranges from, for example, 5 to 50 weight percent, preferably from 10 to 30 weight percent, relative to the weight of the magnetic powder. When employing vinyl chloride resin, the quantity of binder added is preferably from 5 to 30 weight percent; when employing polyurethane resin, from 2 to 20 weight percent; and when employing polyisocyanate, from 2 to 20 weight percent. They may be employed in combination. However, for example, when head corrosion occurs due to the release of trace amounts of chlorine, polyurethane alone or just polyurethane and isocyanate may be employed.

Examples of polyisocyanates are tolylene diisocyanate, 4,4′-diphenylmethane diisocyanate, hexamethylene diisocyanate, xylylene diisocyanate, napthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These polyisocyanates can be synthesized by known methods, and may be commercially available.

In addition to the above-described heterocyclic compound, magnetic powder and binder, the magnetic coating material can comprise one or more additives normally employed in the coating liquid for forming a magnetic layer of a magnetic recording medium, such as abrasives, lubricants, antifungal agents, antistatic agents, oxidation inhibitors, solvents, and carbon black.

Known materials chiefly having a Mohs' hardness of equal to or greater than 6 may be employed either singly or in combination as abrasives. These include: α-alumina with an α-conversion rate of equal to or greater than 90 percent, β-alumina, microgranular diamond, silicon carbide, chromium oxide, cerium oxide, α-iron oxide, corundum, silicon nitride, titanium carbide, titanium oxide, silicon dioxide, and boron nitride. Complexes of these abrasives (obtained by surface treating one abrasive with another) may also be employed. There are cases in which compounds or elements other than the primary compound are contained in these abrasives; the effect does not change so long as the content of the primary compound is equal to or greater than 90 weight percent.

In the coating material of the present invention in the form of a coating liquid for forming a magnetic layer of the magnetic recording medium, the particle size of the abrasive is preferably 0.01 to 1 micrometers. To enhance electromagnetic characteristics, a narrow particle size distribution is desirable. Abrasives of differing particle size may be incorporated as needed to improve durability; the same effect can be achieved with a single abrasive as with a wide particle size distribution. It is preferable that the tap density is 0.3 to 1.5 g/cc, the moisture content is 0.1 to 5 weight percent, the pH is 2 to 11, and the specific surface area is 1 to 40 m²/g. The shape of the abrasive employed may be acicular, spherical, cubic, or the like. However, a shape comprising an angular portion is desirable due to high abrasiveness. Specific examples are AKP-10, AKP-15, AKP-20, AKP-30, AKP-50, HIT-20, HIT-30, HIT-50, HIT-60A, HIT-50G, HIT-70, HIT-80, HIT-82, and HIT-100 made by Sumitomo Chemical Co.,Ltd.; ERC-DBM, HP-DBM, and HPS-DBM made by Reynolds Corp.; WA10000 made by Fujimi Abrasive Corp.; UB20 made by Uemura Kogyo Corp.; G-5, Chromex U2, and Chromex U1 made by Nippon Chemical Industrial Co., Ltd.; TF100 and TF140 made by Toda Kogyo Corp.; Beta Random Ultrafine made by Ibiden Co., Ltd.; and B-3 made by Showa Kogyo Co., Ltd. These abrasives may be added as needed to the coating material of the present invention in the form of a nonmagnetic coating material. Addition of abrasives to the nonmagnetic layer can be done to control surface shape, control how the abrasive protrudes, and the like. The particle size and quantity of the abrasives added to the magnetic layer and nonmagnetic layer should be set to optimal values. The quantity of abrasives employed is, for example, 2 to 20 weight parts relative to 100 weight parts of ferromagnetic powder, as the quantity of abrasives in the magnetic layer, or for example, 2 to 20 weight parts relative to 100 weight parts of nonmagnetic powder as the quantity of abrasives in the nonmagnetic layer.

Examples of lubricants, antifungal agents, antistatic agents, and oxidation inhibitors are: tungsten disulfide, graphite, graphite fluoride, silicone oil, polar group-comprising silicone, fatty acid-modified silicone, fluorosilicone, fluoroalcohols, fluoroesters, polyolefin, polyglycol, polyphenyl ether, phenyl phosphonic acid, benzyl phosphonic acid, phenethyl phosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, nonylphenylphosphonic acid, other aromatic ring-comprising organic phosphonic acids, alkali metal salts thereof, octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, isoeicosylphosphonic acid, other alkyl phosphonoic acid, alkali metal salts thereof, phenyl phosphoric acid, benzyl phosphoric acid, phenethyl phosphoric acid, α-methylbenzylphosphoric acid, 1-methyl-1-phenethylphosphoric acid, diphenylmethylphosphoric acid, diphenyl phosphoric acid, benzylphenyl phosphoric acid, α-cumyl phosphoric acid, toluyl phosphoric acid, xylyl phosphoric acid, ethylphenyl phosphoric acid, cumenyl phosphoric acid, propylphenyl phosphoric acid, butylphenyl phosphoric acid, heptylphenyl phosphoric acid, octylphenyl phosphoric acid, nonylphenyl phosphoric acid, other aromatic phosphoric esters, alkali metal salts thereof, octyl phosphoric acid, 2-ethylhexylphosphoric acid, isooctyl phosphoric acid, isononyl phosphoric acid, isodecyl phosphoric acid, isoundecyl phosphoric acid, isododecyl phosphoric acid, isohexadecyl phosphoric acid, isooctyldecyl phosphoric acid, isoeicosyl phosphoric acid, other alkyl ester phosphoric acids, alkali metal salts thereof, alkylsulfonic acid ester, alkali metal salts thereof, fluorine-containing alkyl sulfuric acid esters, alkali metal salts thereof, lauric acid, myristic acid, palmitic acid, stearic acid, behenic acid, oleic acid, linolic acid, linoleic acid, elaidic acid, erucic acid, other monobasic fatty acids comprising 10 to 24 carbon atoms (which may contain an unsaturated bond or be branched), metal salts thereof, butyl stearate, octyl stearate, amyl stearate, isooctyl stearate, octyl myristate, butyl laurate, butoxyethyl stearate, anhydrosorbitan monostearate, anhydrosorbitan distearate, anhydrosorbitan tristearate, other monofatty esters, difatty esters, or polyfatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 22 carbon atoms (which may contain an unsaturated bond or be branched), alkoxyalcohol having 12 to 22 carbon atoms (which may contain an unsaturated bond or be branched) or a monoalkyl ether of an alkylene oxide polymer, fatty acid amides with 2 to 22 carbon atoms, and aliphatic amines with 8 to 22 carbon atoms. Compounds having aralkyl groups, aryl groups, or alkyl groups substituted with groups other than hydrocarbon groups, such as nitro groups, F, Cl, Br, CF₃, CCl₃, CBr₃, and other halogen-containing hydrocarbons in addition to the above hydrocarbon groups, may also be employed.

It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines. Details of these surfactants are described in A Guide to Surfactants (published by Sangyo Tosho K.K.), which is expressly incorporated herein by reference in its entirety. These additives need not be 100 percent pure and may contain impurities, such as isomers, unreacted material, by-products, decomposition products, and oxides in addition to the main components. These impurities are preferably comprised equal to or less than 30 weight percent, and more preferably equal to or less than 10 weight percent.

Examples of types of carbon black that are suitable for use are: furnace black for rubber, thermal for rubber, black for coloring, conductive carbon black, and acetylene black. It is preferable that the specific surface area is 5 to 500 m²/g, the DBP oil absorption capacity is 10 to 400 ml/100 g, the particle diameter is 5 to 300 nm, the pH is 2 to 10, the moisture content is 0.1 to 10 percent, and the tap density is 0.1 to 1 g/cc. Specific examples of types of carbon black employed are: BLACK PEARLS 2000, 1300, 1000, 900, 905, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemical Corporation; CONDUCTEX SC, RAVEN 150, 50, 40, 15 and RAVEN MT-P from Columbia Carbon Co., Ltd.; and Ketjen Black EC from Ketjen Black International Co., Ltd. The carbon black employed may be surface-treated with a dispersant or grafted with resin, or have a partially graphite-treated surface. The carbon black may be dispersed in advance into the binder prior to addition to the coating liquid. These carbon blacks may be used singly or in combination. In the magnetic layer and nonmagnetic layer, carbon black can work to prevent static, reduce the coefficient of friction, impart light-blocking properties, enhance film strength, and the like; the properties vary with the type of carbon black employed. Accordingly, the type, quantity, and combination of carbon blacks employed in the present invention may be determined separately for the magnetic layer and the nonmagnetic layer based on the objective and the various characteristics stated above, such as particle size, oil absorption capacity, electrical conductivity, and pH, and be optimized for each layer. For example, the Carbon Black Handbook compiled by the Carbon Black Association, which is expressly incorporated herein by reference in its entirety, may be consulted for types of carbon black suitable for use in the present invention.

Known organic solvents can be used in any ratio for the preparation of the coating material. Examples are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane. These organic solvents need not be 100 weight percent pure and may contain impurities such as isomers, unreacted materials, by-products, decomposition products, oxides and moisture in addition to the main components. The content of these impurities is preferably equal to or less than 30 weight percent, more preferably equal to or less than 10 weight percent. To improve dispersion properties, a solvent having a somewhat strong polarity is desirable. It is desirable that solvents having a dielectric constant equal to or higher than 15 are comprised equal to or higher than 50 percent of the solvent composition. Further, the dissolution parameter is desirably 8 to 11.

The coating material of the present invention can be prepared by mixing the above-described heterocyclic compound, powder, binder, and additives as needed. Specifically, it can be prepared by the method normally employed for the preparation of the coating liquid of magnetic layer. The preparation process comprises, for example, a kneading step, a dispersing step, and a mixing step to be carried out, if necessary, before and/or after the kneading and dispersing steps. Each of the individual steps may be divided into two or more stages. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these applications are incorporated herein by reference in their entirety. Further, glass beads may be employed to disperse the magnetic material, with a dispersing medium with a high specific gravity such as zirconia beads, titania beads, and steel beads being suitable for use. The particle diameter and fill ratio of these dispersing media can be optimized for use. A known dispersing device may be employed.

For the addition of the above-described heterocyclic compound to be effective in the coating material of the present invention in the form of a magnetic coating material, the heterocyclic compound is desirably present at the stage where the magnetic powder and binder are brought into contact. This is to prevent the binder from contacting the surface of the magnetic powder before the heterocyclic compound has adhered to the surface of the magnetic powder. Accordingly, the coating material of the present invention in the form of a magnetic coating material is desirably prepared by simultaneously mixing the magnetic powder, the binder and the heterocyclic compound, or by mixing the magnetic powder and the heterocyclic compound to obtain a mixture and then mixing the binder to the mixture.

The above components are desirably specifically mixed by the following methods:
(1) The magnetic powder and the heterocyclic compound are dry dispersed for about 15 to 30 minutes in advance, and then added to an organic solvent. The binder can be simultaneously added with the dispersion, or can be added after the dispersion.
(2) The magnetic powder and the heterocyclic compound are dispersed for about 15 to 30 minutes in an organic solvent, and then dried. The dry mixture is suitably comminuted and then added to an organic solvent. The binder can be simultaneously added with the mixture, or added after the mixture.
(3) The magnetic powder and the heterocyclic compound are dispersed for about 15 to 30 minutes in an organic solvent, after which the binder B is added.
(4) The magnetic powder, the heterocyclic compound and the binder are simultaneously added to an organic solvent and dispersed.

Since magnetic powders can be dispersed with high dispersibility in the magnetic coating material comprising the above-described heterocyclic compound, the coating material of the present invention in the form of a magnetic coating material can be suitably employed as a coating liquid for forming a magnetic layer of the magnetic recording medium, for which high dispersibility is required, and is suitable for use for forming the magnetic layer of the magnetic recording medium of the present invention.

The coating material of the present invention can be a nonmagnetic coating material comprising a nonmagnetic powder, a binder and the above heterocyclic compound. In the nonmagnetic coating material comprising the above heterocyclic compound, the heterocyclic compound can enhance the adhesion between the nonmagnetic powder and the binder, permitting high dispersion of the nonmagnetic powder. The above nonmagnetic coating material is suitable for use as a coating liquid for forming a nonmagnetic layer of the magnetic recording medium for which high dispersibility is required. Details of the heterocyclic compound are as set forth above.

Various components of the coating material in the form of a nonmagnetic coating material will be described below. These components can be employed as the nonmagnetic layer components in the magnetic recording medium of the present invention.

Both organic and inorganic substances may be employed as the nonmagnetic powder. Carbon black may also be employed. Examples of inorganic substances are metals, metal oxides, metal carbonates, metal sulfates, metal nitrides, metal carbides, and metal sulfides. From the perspective of the surface-modifying effect, the nonmagnetic powder is suitably a nonmagnetic metal powder.

Specifically, titanium oxides such as titanium dioxide, cerium oxide, tin oxide, tungsten oxide, ZnO, ZrO₂, SiO₂, Cr₂O₃, α-alumina with an α-conversion rate of 90 to 100 percent, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide may be employed singly or in combinations of two or more. α-iron oxide and titanium oxide are preferred.

The nonmagnetic powder may be acicular, spherical, polyhedral, or plate-shaped. The crystallite size of the nonmagnetic powder preferably ranges from 4 nm to 500 nm, more preferably from 40 to 100 nm. The average particle diameter desirably ranges from 5 to 500 nm, preferably 10 to 200 nm. The nonmagnetic powder with the above-stated size is suitable for use in the coating liquid for forming a nonmagnetic layer of the magnetic recording medium for high-density recording, for which high surface smoothness is required. With the above-described heterocyclic compound, the nonmagnetic powder with the above-stated size can be adequately dispersed in the nonmagnetic coating material.

The specific surface area of the nonmagnetic powder preferably ranges from 1 to 150 m²/g, more preferably from 20 to 120 m²/g, and further preferably from 50 to 100 m²/g. Within the specific surface area ranging from 1 to 150 m²/g, the magnetic recording medium with suitable surface roughness can be formed and dispersion is possible with the desired quantity of binder. Oil absorption capacity using dibutyl phthalate (DBP) preferably ranges from 5 to 100 mL/100 g, more preferably from 10 to 80 mL/100 g, and further preferably from 20 to 60 mL/100 g. The specific gravity ranges from, for example, 1 to 12, preferably from 3 to 6. The tap density ranges from, for example, 0.05 to 2 g/mL, preferably from 0.2 to 1.5 g/mL. A tap density falling within a range of 0.05 to 2 g/mL can reduce the amount of scattering particles, thereby facilitating handling, and tends to prevent solidification to the device. The pH of the nonmagnetic powder preferably ranges from 2 to 11, more preferably from 6 to 9. When the pH falls within a range of 2 to 11, the coefficient of friction does not become high at high temperature or high humidity or due to the freeing of fatty acids. The moisture content of the nonmagnetic powder ranges from, for example, 0.1 to 5 weight percent, preferably from 0.2 to 3 weight percent, and more preferably from 0.3 to 1.5 weight percent. A moisture content falling within a range of 0.1 to 5 weight percent is desirable because it can produce good dispersion and yield a stable coating viscosity following dispersion. An ignition loss of equal to or less than 20 weight percent is desirable and nonmagnetic powders with low ignition losses are desirable.

When the nonmagnetic powder is an inorganic powder, the Mohs' hardness is preferably 4 to 10. Durability of the magnetic recording medium can be ensured if the Mohs' hardness ranges from 4 to 10. The stearic acid (SA) adsorption capacity of the nonmagnetic powder preferably ranges from 1 to 20 μmol/m², more preferably from 2 to 15 μmol/m². The heat of wetting in 25° C. water of the nonmagnetic powder is preferably within a range of 200 to 600 erg/cm² (approximately 200 to 600 mJ/m²). A solvent with a heat of wetting within this range may also be employed. The quantity of water molecules on the surface at 100 to 400° C. suitably ranges from 1 to 10 pieces per 100 Angstroms. The pH of the isoelectric point in water preferably ranges from 3 to 9. The surface of these nonmagnetic powders is preferably treated with Al₂O₃, SiO₂, TiO₂, ZrO₂, SnO₂, Sb₂O₃, and ZnO. The surface-treating agents of preference with regard to dispersibility are Al₂O₃, SiO₂, TiO₂, and ZrO₂, and Al₂O₃, SiO₂ and ZrO₂ are further preferable. They may be employed singly or in combination. Depending on the objective, a surface-treatment coating layer with a coprecipitated material may also be employed, the coating structure which comprises a first alumina coating and a second silica coating thereover or the reverse structure -thereof may also be adopted. Depending on the objective, the surface-treatment coating layer may be a porous layer, with homogeneity and density being generally desirable.

Specific examples of nonmagnetic powders suitable for use in the nonmagnetic layer in the present invention are: Nanotite from Showa Denko K. K.; HIT-100 and ZA-G1 from Sumitomo Chemical Co., Ltd.; DPN-250, DPN-250BX, DPN-245, DPN-270BX, DPN-550BX and DPN-550RX from Toda Kogyo Corp.; titanium oxide TTO-51B, TTO-55A, TTO-55B, TTO-55C, TTO-55S, TTO-55D, SN-100, MJ-7, α-iron oxide E270, E271 and E300 from Ishihara Sangyo Co., Ltd.; STT-4D, STT-30D, STT-30 and STT-65C from Titan Kogyo K. K.; MT-100S, MT-100T, MT-150W, MT-500B, MT-600B, MT-100F and MT-500HD from Tayca Corporation; FINEX-25, BF-1, BF-10, BF-20 and ST-M from Sakai Chemical Industry Co., Ltd.; DEFIC-Y and DEFIC-R from Dowa Mining Co., Ltd.; AS2BM and TiO2P25 from Nippon Aerogil; 100A and 500A from Ube Industries, Ltd.; Y-LOP from Titan Kogyo K. K.; and sintered products of the same. Particular preferable nonmagnetic powders are titanium dioxide and α-iron oxide.

Details of the binder that is added to the nonmagnetic coating material are identical to those of the binder incorporated in the magnetic coating liquid as described above. The various additives and solvents that are employed in the magnetic recording medium can also be incorporated into the nonmagnetic coating material. Details of the various components of the nonmagnetic coating liquid, methods of mixing them, and the quantities that are added are identical to those in the description given for the magnetic coating material as set forth above.

Since the nonmagnetic powder can be dispersed to a high degree in the coating material of the present invention in the form of a nonmagnetic coating material, it is suitable for use as a coating liquid for forming a nonmagnetic layer of magnetic recording media in which a high degree of dispersibility is required, and can be employed to form the nonmagnetic layer of the magnetic recording medium of the present invention.

### EXAMPLES

The present invention will be described in greater detail below through Examples. The components, ratios, operations, sequences, and the like indicated here can be modified without departing from the spirit of the present invention, and are not to be construed as being limited to Examples set forth below. The “parts” given in Examples denote weight parts unless specifically indicated otherwise.

1. Examples and comparative examples employing ferromagnetic hexagonal ferrite powder

### Example 1

A suspension was prepared from 2.2 weight parts of the ferromagnetic hexagonal ferrite powder indicated below, 1 weigh part of sulfonic acid group-containing polyurethane (sulfonic acid group content: 3.3×10⁻⁴ mol/g), and 0.09 weight part of 4-pyridinecarboxylic acid in a solution comprised of 3.3 weight parts of cyclohexanone and 4.9 weight parts of 2-butanone. Twenty-seven weight parts of zirconia beads (made by Nikkato) were added to the suspension and the mixture was dispersed for 6 hours. The ratio of the polyurethane on the surface of the ferromagnetic hexagonal ferrite powder dispersed in the solution to the polyurethane present in the solution was 5.2/1 as measured by the method set forth further below. The ratio of the 4-pyridinecarboxylic acid on the surface of the ferromagnetic hexagonal ferrite powder to that in the solution was 5.7/1 as measured by the method set forth below.

Ferromagnetic Hexagonal Barium Ferrite Powder

Composition other than oxygen (molar ratio): Ba/Fe/Co/Zn=1/9/0.2/1

Hc: 176 kA/m (approximately 2200 Oe)

Average plate diameter: 25 nm

Average plate ratio: 3

Specific surface area by BET method: 65 m²/g

σs: 49 A·m²/kg (approximately 49 emu/g)

pH: 7

[Measurement Method]

A compact separation ultracentrifuge, the CS150GXL made by Hitachi, was used to centrifugally separate the ferromagnetic hexagonal ferrite powder and the solution for 80 minutes at 100,000 rpm. A 3 mL quantity of the supernatant was measured out and weighed. The supernatant was dried at 40° C. for 18 hours and then under vacuum at 140° C. for 3 hours. The weight of the dried mixture was adopted as the solid component of unadsorbed binder and used to calculate the ratio of binder on the surface of the ferromagnetic powder surface to that in the solution.

A 3 mL quantity of the supernatant obtained by the above centrifugal separation was measured out and weighed. The supernatant was dissolved in N,N-dimethylformamide and the pH was adjusted with 0.1 N hydrochloric acid. Titration was conducted with an automatic titrator, the GT-100/win made by Mitsubishi Chemicals, to measure the weight of the 4-pyridinecarboxylic acid contained in the supernatant, and the ratio present on the surface of the ferromagnetic hexagonal ferrite powder to that in the solution was calculated.

### Comparative Example 1

With the exception that 0.12 weight part of phenylphosphonic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 3.6/1 as measured by the above method. The ratio of the phenylphosphonic acid on the surface of the ferromagnetic powder to that in the solution was 100/1 or greater as measured by the above method.

### Comparative Example 2

With the exception that 0.13 weight part of benzenesulfonic acid monohydrate was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 2.9/1 as measured by the above method. The ratio of the benzenesulfonic acid monohydrate on the surface of the ferromagnetic powder to that in the solution was 100/1 or greater as measured by the above method.

### Comparative Example 3

With the exception that 0.07 weight part of phenol was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 4.9/1 as measured by the above method. The ratio of the phenol on the surface of the ferromagnetic powder to that in the solution was 1.5/1 as measured by the above method.

### Comparative Example 4

With the exception that 0.09 weight part of benzoic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 4.9/1 as measured by the above method. The ratio of the benzoic acid on the surface of the ferromagnetic powder to that in the solution was 1.2/1 as measured by the above method.

### Comparative Example 5

With the exception that no 4-pyridinecarboxylic acid was added, a dispersion solution was obtained by the same process as in Example 1. The ratio of the polyurethane on the surface of the ferromagnetic powder dispersed in the solution to the polyurethane present in the solution was 2.6/1 as measured by the above method.

The ratio of the polyurethane on the surface of the ferromagnetic powder in Example 1 was higher than the ratio of the polyurethane on the surface of the ferromagnetic powder in any of Comparative Examples 1 to 5. Thus, 4-pyridine-carboxylic acid was found to modify the surface of the ferromagnetic powder and increase the level of polyurethane adsorption. Since the increased level of binder adsorption to the magnetic powder in the magnetic coating material is linked to improved magnetic powder dispersibility, 4-pyridinecarboxylic acid was found to function as a dispersing agent in the magnetic coating material.

The ratio of the surface-modifying agent (4-pyridinecarboxylic acid) on the surface of the ferromagnetic powder in Example 1 was also higher than the ratio of the surface-modifying agents (phenol and benzoic acid) in Comparative Examples 3 and 4 on the surface of the ferromagnetic powder. Thus, 4-pyridinecarboxylic acid was found to bond strongly to ferromagnetic powder. Since there was little free 4-pyridine-carboxylic acid in the magnetic coating material, the use of the magnetic coating material to form the magnetic layer was thought to permit the formation of a magnetic recording medium producing little head grime and affording good running durability.

### Example 2

With the exception that 0.09 weight part of 3-pyridinecarboxylic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 9.6/1 as measured by the above method. The ratio of the 3-pyridinecarboxylic acid on the surface of the ferromagnetic powder to that in the solution was 4.9/1 as measured by the above method.

### Example 3

With the exception that 0.13 weight part of 4-hydroxypyridine-2,6-dicarboxylic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 7.5/1 as measured by the above method. The ratio of the 4-hydroxypyridine-2,6-dicarboxylic acid on the surface of the ferromagnetic powder to that in the solution was 4.1/1 as measured by the above method.

### Example 4

With the exception that 0.11 weight part of 2,6-dihydroxypyridine-4-carboxylic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 5.7/1 as measured by the above method. The ratio of the 2,6-dihydroxypyridine-4-carboxylic acid on the surface of the ferromagnetic powder to that in the solution was 4.0/1 as measured by the above method.

### Example 5

With the exception that 0.13 weight part of 2-quinolinecarboxylic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 5.8/1 as measured by the above method. The ratio of the 2-quinolinecarboxylic acid on the surface of the ferromagnetic powder to that in the solution was 4.0/1 as measured by the above method.

### Example 6

With the exception that 0.11 weight part of 2-hydroxynicotinic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 10.2/1 as measured by the above method. The ratio of the 2-hydroxynicotinic acid on the surface of the ferromagnetic powder to that in the solution was 4.0/1 as measured by the above method.

### Example 7

With the exception that 0.11 weight part of 6-hydroxypicolinic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 6.4/1 as measured by the above method. The ratio of the 6-hydroxypicolinic acid on the surface of the ferromagnetic powder to that in the solution was 4.0/1 as measured by the above method.

### Example 8

With the exception that 0.13 weight part of 2,6-pyridinedicarboxylic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 6.4/1 as measured by the above method. The ratio of the 2,6-pyridinedicarboxylic acid on the surface of the ferromagnetic powder to that in the solution was 3.9/1 as measured by the above method.

### Example 9

With the exception that 0.09 weight part of pyrazinecarboxylic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 6.7/1 as measured by the above method. The ratio of the pyrazinecarboxylic acid on the surface of the ferromagnetic powder to that in the solution was 3.8/1 as measured by the above method.

### Example 10

With the exception that 0.13 weight part of 2,3-pyridinedicarboxylic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 6.8/1 as measured by the above method. The ratio of the 2,3-pyridine-dicarboxylic acid on the surface of the ferromagnetic powder to that in the solution was 3.9/1 as measured by the above method.

### Example 11

With the exception that 0.07 weight part of 2-hydroxypyridine was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 5.9/1 as measured by the above method. The ratio of the 2-hydroxypyridine on the surface of the ferromagnetic powder to that in the solution was 5.0/1 as measured by the above method.

### Example 12

With the exception that 0.07 weight part of 3-hydroxypyridine was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 6.3/1 as measured by the above method. The ratio of the 3-hydroxypyridine on the surface of the ferromagnetic powder to that in the solution was 5.3/1 as measured by the above method.

### Example 13

With the exception that the quantity of 4-pyridinecarboxylic acid employed was changed from 0.09 weight part to 0.07 weight part, a dispersion solution was obtained by the same process as in Example 1. The ratio of the polyurethane on the surface of the ferromagnetic powder dispersed in the solution to the polyurethane present in the solution was 6.5/1 as measured by the above method.

### Example 14

With the exception that 0.08 weight part of 2,3-dihydroxypyridine was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 11.3/1 as measured by the above method. The ratio of the 2,3-dihydroxypyridine on the surface of the ferromagnetic powder to that in the solution was 4.3/1 as measured by the above method.

### Example 15

With the exception that 0.09 weight part of 2-furancarboxylic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 46.2/1 as measured by the above method. The ratio of the 2-furancarboxylic acid on the surface of the ferromagnetic powder to that in the solution was 4.0/1 as measured by the above method.

### Example 16

With the exception that 0.08 weight part of pyrrole-2-carboxylic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 10.2/1 as measured by the above method. The ratio of the pyrrole-2-carboxylic acid on the surface of the ferromagnetic powder to that in the solution was 4.1/1 as measured by the above method.

### Example 17

With the exception that 0.09 weight part of 2-thiophenecarboxylic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 22.6/1 as measured by the above method. The ratio of the 2-thiophenecarboxylic acid on the surface of the ferromagnetic powder to that in the solution was 4.0/1 as measured by the above method.

### Example 18

With the exception that 0.10 weight part of 3-piperidinecarboxylic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 6.5/1 as measured by the above method. The ratio of the 3-piperidinecarboxylic acid on the surface of the ferromagnetic powder to that in the solution was 4.0/1 as measured by the above method.

### Example 19

With the exception that 0.07 weight part of 4-hydroxypyridine was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 6.5/1 as measured by the above method. The ratio of the 4-hydroxypyridine on the surface of the ferromagnetic powder to that in the solution was 3.8/1 as measured by the above method.

### Comparative Example 6

With the exception that 0.13 weight part of 1,2-benzenedicarboxylic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 2.6/1 as measured by the above method. The ratio of the 1,2-benzenedicarboxylic acid on the surface of the ferromagnetic powder to that in the solution was 3.3/1 as measured by the above method.

### Comparative Example 7

With the exception that 0.10 weight part of salicylic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 3.6/1 as measured by the above method. The ratio of the salicylic acid on the surface of the ferromagnetic powder to that in the solution was 2.8/1 as measured by the above method.

### Comparative Example 8

With the exception that 0.08 weight part of 1,3-dihydroxybenzene was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 4.0/1 as measured by the above method. The ratio of the 1,3-dihydroxybenzene on the surface of the ferromagnetic powder to that in the solution was 4.0/1 as measured by the above method.

### Comparative Example 9

With the exception that 0.12 weight part of phenylphosphonic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 3.6/1 as measured by the above method. The ratio of the phenylphosphonic acid on the surface of the ferromagnetic powder to that in the solution was measured by the above method, however, no phenylphosphonic acid was detected in the solution.

### Comparative Example 10

With the exception that 0.17 weight part of biphenylphosphonic acid was employed instead of the 0.09 weight part of 4-pyridinecarboxylic acid, a dispersion solution was obtained by the same process as in Example 1. The ratio of the polyurethane on the surface of the ferromagnetic powder dispersed in the solution to the polyurethane present in the solution was 4.0/1 as measured by the above method. The ratio of the biphenylphosphonic acid on the surface of the ferromagnetic powder to that in the solution was measured by the above method, however, no biphenylphosphonic acid was detected in the solution.

2. Examples and comparative examples employing ferromagnetic metal powder

### Example 20

With the exception that 2.2 weight parts of ferromagnetic metal powder indicated below were employed instead of 2.2 weight parts of ferromagnetic hexagonal powder, a dispersion solution was obtained by the same process as in Example 15 (employing 0.09 weight part of 2-furancarboxylic acid). The ratio of the polyurethane on the surface of the ferromagnetic powder dispersed in the solution to the polyurethane present in the solution was 0.92/1 as measured by the above method. The ratio of the 2-furancarboxylic acid on the surface of the ferromagnetic powder to that in the solution was 4.2/1 as measured by the above method.

Ferromagnetic Metal Powder

Composition: Co/Fe: 23.7 atomic %, Y/Fe:15.3 atomic %, Al/Fe:9.3 atomic %

Hc:194 kA/m (approximately 2400 Oe)

Average major axis length: 45 nm

Average acicular ratio: 4.2

Specific surface area by BET method: 67 m²/g

σs: 110 A·m²/kg (approximately 110 emu/g)

pH:9

### Example 21

With the exception that 0.09 weight part of 2-thiophenecarboxylic acid was employed instead of 0.09 weight part of 2-furancarboxylic acid, a dispersion solution was obtained by the same process as in Example 20. The ratio of the polyurethane on the surface of the ferromagnetic powder dispersed in the solution to the polyurethane present in the solution was 0.74/1 as measured by the above method. The ratio of the 2-thiophenecarboxylic acid on the surface of the ferromagnetic powder to that in the solution was 4.2/1 as measured by the above method.

### Comparative Example 11

With the exception that no 2-furancarboxylic acid was added, a dispersion solution was obtained by the same process as in Example 20. The ratio of the polyurethane on the surface of the ferromagnetic powder dispersed in the solution to the polyurethane present in the solution was 0.52/1 as measured by the above method.

Since the ratio of the polyurethane on the surface of the ferromagnetic powder in Examples 20 and 21 was higher than the ratio of the polyurethane on the surface of the ferromagnetic powder in Comparative Example 11, 2-furancarboxylic acid and 2-thiophenecarboxylic acid were found to modify the surface of the ferromagnetic powder and have the effect of increasing the level of polyurethane adsorption. As set forth above, increasing the quantity of binder adsorbing onto the magnetic powder in the magnetic coating material is linked to improving the dispersibility of the magnetic powder. Thus, since the addition of 2-furancarboxylic acid and 2-thiophenecarboxylic acid increased the quantity of binder adsorbing onto the magnetic powder, these compounds were confirmed to function as dispersing agents in the magnetic coating material. From the results of measurement of the ratio of 2-furancarboxylic acid and 2-thiophenecarboxylic acid on the surface of the ferromagnetic powder to that in the solution, these compounds were confirmed to have good adsorptivity to the magnetic powder.

3. Examples and Comparative Examples Employing Nonmagnetic Powder

### Example 22

A suspension was prepared from 1.1 weight parts of the nonmagnetic powder indicated below, 1 weigh part of sulfonic acid group-containing polyurethane (sulfonic acid group content: 3.3×10⁻⁴ mol/g), and 0.04 weight part of 2-hydroxypyridine in a solution comprised of 3.3 weight parts of cyclohexanone and 4.9 weight parts of 2-butanone. Twenty-seven weight parts of zirconia beads (made by Nikkato) were added to the suspension and the mixture was dispersed for 6 hours. The ratio of the polyurethane on the surface of the nonmagnetic powder dispersed in the solution to the polyurethane present in the solution was 0.31/1 as measured by the above method. The ratio of the 2-hydroxypyridine on the surface of the nonmagnetic powder to that in the solution was 4.5/1 as measured by the above method.

Nonmagnetic Powder

α-iron oxide

Surface treatment layer: Al₂O₃, SiO₂

Average major axis length: 0.15 micrometer

Average acicular ratio: 7

Specific surface area by BET method: 52 m²/g

pH: 8

### Example 23

With the exception that 0.05 weight part of 4-pyridinecarboxylic acid was employed instead of the 0.04 weight part of 2-hydroxypyridine, a dispersion solution was obtained by the same process as in Example 22. The ratio of the polyurethane on the surface of the nonmagnetic powder dispersed in the solution to the polyurethane present in the solution was 0.32/1 as measured by the above method. The ratio of the 4-pyridinecarboxylic acid on the surface of the nonmagnetic powder to that in the solution was 5.2/1 as measured by the above method.

### Comparative Example 12

With the exception that no 2-hydroxypyridine was added, a dispersion solution was obtained by the same process as in Example 22. The ratio of the polyurethane on the surface of the nonmagnetic powder dispersed in the solution to the polyurethane present in the solution was 0.22/1 as measured by the above method.

Since the ratio of the polyurethane on the surface of the nonmagnetic powder in Examples 22 and 23 was higher than the ratio of the polyurethane on the surface of the nonmagnetic powder in Comparative Example 12, 2-hydroxypyridine and 4-pyridinecarboxylic acid were found to modify the surface of the nonmagnetic powder and have the effect of increasing the level of polyurethane adsorption. Increasing the quantity of binder adsorbing onto the nonmagnetic powder in the nonmagnetic coating material is linked to improving the dispersibility of the nonmagnetic powder. Thus, since the addition of 2-hydroxypyridine and 4-pyridinecarboxylic acid increased the quantity of binder adsorbing onto the nonmagnetic powder, these compounds were confirmed to function as dispersing agents in the nonmagnetic coating material. From the results of measurement of the ratio of 2-hydroxypyridine and 4-pyridinecarboxylic acid on the surface of the nonmagnetic powder to that in the solution, these compounds were confirmed to have good adsorptivity to the nonmagnetic powder.

4. Confirmation of the Adsorptivity to the Magnetic Powder

In a mixed solvent of 25 weight parts of cyclohexanone and 12 weight parts of 2-butanone were suspended 8 weight parts of barium ferrite magnetic powder and the compound listed in Table 1, and the mixture was stirred for 20 minutes with a magnetic stirrer. The solution was left standing and the quantity of the compound listed in Table 1 in the supernatant was measured by titration by the method set forth below. The results are given in Table 1.

[Measurement Method]

The suspension was left standing, and 3 mL of the supernatant was measured out and weighed. The supernatant was dissolved in N,N-dimethylformamide and the pH was adjusted with 0.1 N hydrochloric acid. Titration was conducted with an automatic titrator, the GT-100/win made by Mitsubishi Chemicals, to measure the weight of the compound listed in Table 1 contained in the supernatant.

TABLE 1

| | Quantity in the supernatant |
|---|---|
| 4-hydroxypyridine (0.24 weight part) | Not detected |
| Phenol (0.24 weight part) | 0.03 weight part |
| Benzenesulfonic acid (0.44 weight part) | Not detected |
| Phenylphosphonic acid (0.40 weight part) | Not detected |

5. Confirmation of Adsorptivity to the Magnetic Powder in the Presence of Binder

In a solution comprised of 3.3 weight parts of cyclohexanone and 4.9 weight parts of 2-butanone were suspended 2.2 weight parts of ferromagnetic hexagonal ferrite powder, 1 weight part of sulfonic acid group-containing polyurethane (sulfonic acid group content: 3.3×10⁻⁴ mol/g), and the compound listed in Table 2. To the suspension were added 27 weight parts of zirconia beads (made by Nikkato) and the mixture was dispersed for 6 hours. The ratio of the compound listed in Table 2 on the surface of the ferromagnetic powder dispersed in the solution to that present in the solution was measured by the above-described method. The results are given in Table 2.

TABLE 2

| | Ratio of the compound |
|---|---|
| | present on the surface of the |
| | ferromagnetic powder surface/ |
| | that in the solution |
| 4-pyridinecarboxylic acid (0.09 weight | 5.7/1 |
| part) | |
| 4-hydroxypyridine (0.07 weight part) | 4.0/1 |
| Benzoic acid (0.09 weight part) | 1.6/1 |
| Phenol (0.07 weight part) | 1.5/1 |

6. Confirmation of Compatibility Between Binder and Surface-Modifying Agent

In 3.3 weight parts of cyclohexanone and 2.3 weight parts of 2-butanone were dissolved 1 weight part of sulfonic acid group-containing polyurethane (sulfonic acid group content: 3.3×10⁻⁴ mol/g) and the compound listed in Table 3, and the mixture was stirred for 1 hour with a magnetic stirrer. A 0.1 mL quantity of the liquid was measured out, placed on an OHP sheet, and dried under conditions of 70° C. and ordinary pressure for 48 hours. The dried sample was visually evaluated to confirm compatibility. The compatibility of samples that were transparent was evaluated as “Good” and that of samples that were cloudy as “Poor”. The results are given in Table 3.

TABLE 3

| | Quantity added (weight percent) | | | | |
|---|---|---|---|---|---|
| Compound | 0.5 | 1.0 | 2.0 | 3.0 | 5.0 |
| Phenylphosphonic acid | Good | Good | Poor | Poor | Poor |
| Benzenesulfonic acid monohydrate | Good | Poor | Poor | Poor | Poor |
| Phenol | Good | Good | Good | Good | Good |
| 4-hydroxypyridine | Good | Good | Good | Good | Good |
| 2-thiophenecarboxylic acid | Good | Good | Good | Good | Good |
| 2-furancarboxylic acid | Good | Good | Good | Good | Good |

As indicated in Comparative Examples 2 and 9, although benzenesulfonic acid and phenylphosphonic acid bonded well to ferromagnetic powder, the adsorptivity of the binder to the ferromagnetic powder was not adequately enhanced. This was attributed to low affinity to the binder, as shown in Table 3.

By contrast, as indicated in Comparative Example 3 and 4, although phenol and benzoic acid had relatively strong effects in enhancing the adsorptivity of binder to ferromagnetic powder, the quantities of these compounds present in the magnetic coating material was high. This was attributed to the relative low adsorptivity of phenol and benzoic acid to the magnetic powder, as indicated in Tables 1 and 2.

By contrast, as indicated in Table 1 to 3, heterocyclic compounds comprising hydroxyl and/or carboxyl groups both bonded well to magnetic powder and had good affinity for binder. The enhanced adsorptivity of binder to magnetic powder and reduction of free components achieved with the heterocyclic compound as indicated in the Examples was attributed to this.

7. Examples and Comparative Examples of Magnetic Recording Medium

### Example 24

<Magnetic layer coating liquid>

| | | |
|---|---|---|
| Ferromagnetic metal powder indicated above | 100 | parts |
| 4-pyridinecarboxylic acid | 5 | parts |
| Vinyl chloride copolymer (MR104 made by | 7 | parts |
| Nippon Zeon Co., Ltd.) | | |
| Sulfonic acid group-containing polyurethane | 15 | parts |
| (sulfonic acid group content: 6.0 × 10⁻⁵ mol/g) | | |
| α-Al₂O₃ (Mohs's hardness: 9, | 13 | parts |
| average particle diameter: 0.1 micrometer) | | |
| Carbon black (average particle diameter: | 0.5 | part |
| 0.08 micrometer) | | |
| Butyl stearate | 2 | parts |
| Stearic acid | 1 | part |
| Amide stearate | 0.3 | part |
| Methyl ethyl ketone | 250 | parts |
| Cyclohexanone | 250 | parts |
| Toluene | 2 | parts |

The various components of the above-described magnetic layer coating liquid were kneaded in an open kneader and then dispersed using a sand mill. To the dispersion obtained were added 3 parts of polyisocyanate compound (Coronate 3041 made by Nippon Polyurethane Industry Co., Ltd.), the mixture was further dispersed, and filtration was conducted with a filter having an average pore diameter of 1 micrometer to prepare the magnetic layer coating liquid.

<Nonmagnetic layer coating liquid>

| | | |
|---|---|---|
| Nonmagnetic powder indicated above (α-Fe₂O₃ hematite) | 80 | parts |
| Carbon black (average particle diameter: 0.18 | 20 | parts |
| micrometer) | | |
| Phenylphosphonic acid | 3 | parts |
| Vinyl chloride copolymer (MR104 made by | 12 | parts |
| Nippon Zeon Co., Ltd.) | | |
| Sulfonic acid group-containing polyurethane | 7 | parts |
| (sulfonic acid group content: 6.0 × 10⁻⁵ mol/g) | | |
| Butyl stearate | 2 | parts |
| Stearic acid | 1 | part |
| Amide stearate | 0.3 | part |
| Methyl ethyl ketone | 150 | parts |
| Cyclohexanone | 250 | parts |
| Toluene | 3 | parts |

The various components of the above-described nonmagnetic layer coating liquid were kneaded in an open kneader and then dispersed using a sand mill. To the dispersion obtained were added 5 parts of polyisocyanate compound (Coronate 3041 made by Nippon Polyurethane Industry Co., Ltd.), the mixture was further dispersed, and filtration was conducted with a filter having an average pore diameter of 1 micrometer to prepare the nonmagnetic layer coating liquid.

<Backcoat layer coating liquid>

| | | |
|---|---|---|
| Carbon black (average particle diameter: 40 nm) | 85 | parts |
| Carbon black (average particle diameter: 100 nm) | 3 | parts |
| Nitrocellulose | 28 | parts |
| Polyurethane resin | 58 | parts |
| Copper phthalocyanine-based dispersing agent | 2.5 | parts |
| Polyurethane resin (Nippollan 2301 made by | 0.5 | part |
| Nippon Polyurethane Co., Ltd.) | | |
| Methyl isobutyl ketone | 0.3 | part |
| Methyl ethyl ketone | 860 | parts |
| Toluene | 240 | parts |

After preliminary kneading the above components in a roll mill, the mixture was dispersed with a sand mill. Four parts of polyester resin (Vylon 500 made by Toyobo Co., Ltd.), 14 parts of polyisocyanate compound (Coronate 3041 made by Nippon Polyurethane Industry Co., Ltd.), and 5 parts of α-Al₂O₃ (made by Sumitomo Chemicals) were added and the mixture was stirred to prepare a backcoat layer coating liquid.

A simultaneous multilayer coating was conducted by coating the nonmagnetic layer coating liquid in a manner yielding a dry thickness of 1.0 micrometer immediately followed by the magnetic layer coating liquid in a manner yielding a dry thickness of 0.08 micrometer on a polyethylene naphthalate resin support having a thickness of 6 micrometers with a magnetic layer coating surface with a center surface average roughness of 0.003 micrometer. While still wet, the two layers were oriented with cobalt magnets having a magnetic force of 0.5 T (approximately 5,000 G) and solenoids having a magnetic force of 0.4 T (approximately 4,000 G), and then dried. A 0.6 micrometer backcoat layer was then coated to the reverse side from the magnetic layer. Subsequently, calendering was conducted with a seven-stage calender comprised solely of metal rolls at a temperature of 80° C. and a rate of 80 m/min. The material was then slit into a ½ inch width to obtain a magnetic recording tape.

### Example 25

With the exception that 5 parts of 3-pyridinecarboxylic acid were employed instead of 5 parts of 4-pyridinecarboxylic acid in the magnetic layer coating liquid, a magnetic tape was manufactured by the same process as in Example 24.

### Comparative Example 13

With the exception that 5 parts of benzoic acid were employed instead of 5 parts of 4-pyridinecarboxylic acid in the magnetic layer coating liquid, a magnetic tape was manufactured by the same process as in Example 24.

[Evaluation Methods]

### (1) Magnetic Tape Surface Roughness

The center surface average roughness Ra of the magnetic layer of the magnetic tape was obtained by the scanning white light interference method at a scan length of 5 micrometers with a NewView 5022 general-purpose 3D surface profiler made by Zygo Corp. at a 20× objective lens magnification and a 1.0× zoom lens magnification for a measurement field of 260×350 micrometers. The surface measured was filter processed with a HPF of 1.65 micrometers and a LPF of 50 micrometers.

### (2) Frictional Coefficient of the Magnetic Tape

In a 23° C., 50 percent RH environment, the tape was contacted with an AlTiC bar (wind angle: 170°) the surface of which had been smoothed. A 100 g (T1) load was applied on one side and maintained on the other side with a load cell, and the tension (T2) required to run a 45 mm length of sample in the horizontal direction at a speed of 14 mm/s was measured. The measured value was then used to calculate the value of frictional coefficient μ on the 100th pass using the following equation:

μ=(1/π)·ln(T2/T1).

TABLE 4
Evaluation results

| | | μ value on the |
|---|---|---|
| | ZYGO-Ra | 100^{th} pass |
| Example 24 | 2.03 | 0.49 |
| Example 25 | 2.16 | 0.46 |
| Comparative | 2.43 | 0.52 |
| Example 13 | | |

The magnetic tapes of Examples 24 and 25 had lower levels of magnetic tape surface roughness than the magnetic tape of Comparative Example 13. This was attributed to the adsorption of a greater quantity of binder to the magnetic powder and enhanced dispersion of the magnetic powder achieved by employing a magnetic layer component in the form of a compound having a carboxyl group and a heterocyclic ring. Examples 24 and 25 also had lower frictional coefficients than that of the magnetic tape of Comparative Example 13, affording enhanced running durability when used as the above heterocyclic compound.

The above-described heterocyclic compound is suitable as a dispersing agent for magnetic and nonmagnetic coating material.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. A method of modifying a surface of a powder, comprising mixing a powder with a heterocyclic compound comprising at least one hydroxylic group and/or carboxylic group.

2. The method of modifying a surface of a powder according to claim 1, wherein the heterocyclic compound comprises at least one heterocyclic ring selected from the group consisting of aromatic heterocyclic rings and aliphatic heterocyclic rings.

3. The method of modifying a surface of a powder according to claim 2, wherein the aromatic heterocyclic ring is at least one aromatic heterocyclic ring selected from the group consisting of pyridine, pyrazine, pyrrole, piperidine, thiophene, quinoline, and furan rings.

4. The method of modifying a surface of a powder according to claim 1, wherein the powder is a magnetic powder or a nonmagnetic powder.

5. The method of modifying a surface of a powder according to claim 1, wherein the powder is a magnetic powder or a nonmagnetic powder comprised in a coating material, and the surface of the powder is modified to improve dispersibility of the powder in the coating material.

6. A magnetic recording medium comprising a magnetic layer comprising a ferromagnetic powder and a binder on a nonmagnetic support, wherein
the magnetic layer comprises a heterocyclic compound comprising at least one hydroxylic group and/or carboxylic group.

7. The magnetic recording medium according to claim 6, wherein the heterocyclic compound comprises at least one heterocyclic ring selected from the group consisting of aromatic heterocyclic rings and aliphatic heterocyclic rings.

8. The magnetic recording medium according to claim 7, wherein the aromatic heterocyclic ring is at least one aromatic heterocyclic ring selected from the group consisting of pyridine, pyrazine, pyrrole, piperidine, thiophene, quinoline, and furan rings.

9. The magnetic recording medium according to claim 6, wherein the binder comprises a sulfonic acid group.

10. The magnetic recording medium according to claim 6, further comprising a nonmagnetic layer comprising a nonmagnetic powder and a binder between the nonmagnetic support and the magnetic layer.

11. The magnetic recording medium according to claim 10, wherein the nonmagnetic layer comprises a heterocyclic compound comprising at least one hydroxylic group and/or carboxylic group.

12. The magnetic recording medium according to claim 11, wherein the heterocyclic compound comprises at least one heterocyclic ring selected from the group consisting of aromatic heterocyclic rings and aliphatic heterocyclic rings.

13. The magnetic recording medium according to claim 12, wherein the aromatic heterocyclic ring is at least one aromatic heterocyclic ring selected from the group consisting of pyridine, pyrazine, pyrrole, piperidine, thiophene, quinoline, and furan rings.

14. The magnetic recording medium according to claim 10, wherein the binder comprises a sulfonic acid group.

15. A coating material comprising a powder and a binder, further comprising a heterocyclic compound comprising at least one hydroxylic group and/or carboxylic group.

16. The coating material according to claim 15, wherein the heterocyclic compound comprises at least one heterocyclic ring selected from the group consisting of aromatic heterocyclic rings and aliphatic heterocyclic rings.

17. The coating material according to claim 16, wherein aromatic heterocyclic ring is at least one aromatic heterocyclic ring selected from the group consisting of pyridine, pyrazine, pyrrole, piperidine, thiophene, quinoline, and furan rings.

18. The coating material according to claim 15, wherein the binder comprises a sulfonic acid group.

19. The coating material according to claim 15, which is a magnetic coating material comprising the powder in the form of a magnetic powder or a nonmagnetic coating material comprising the powder in the form of a nonmagnetic powder.

20. The coating material according to claim 15, which is a coating liquid for forming a magnetic layer or a nonmagnetic layer of a magnetic recording medium.
